(19) United States
(12) Patent Application Publication
(10) Pub. No.: US 2026/0187979 A1
(43) Pub. Date: Jul. 2, 2026

(54) ASCERTAINING SYSTEMATIC ERRORS IN IMAGE CLASSIFIERS

(71) Applicant: Robert Bosch GmbH, Stuttgart (DE)

(72) Inventors: Dan Zhang, Leonberg (DE); Jan Hendrik Metzen, Boeblingen (DE); Nian Hua, Magstadt (DE); Robin Hutmacher, Renningen (DE)

(21) Appl. No.: 19/129,806

(22) PCT Filed: Jan. 11, 2024
(86) PCT No.: PCT/EP2024/050546

§ 371 Date: May 14, 2025

(30) Foreign Application Priority Data
Jan. 25, 2023 (DE) 10 2023 200 586.7

(51) Int. Cl. G06V 10/764; G06T 11/00

(52) U.S. Cl. CPC G06V 10/764; G06T 11/00

(57) ABSTRACT

A computer-implemented method for ascertaining at least one systematic error during the classification of images into at least one image category by a classification algorithm. The method includes: providing a list of image features and respective value indications for each of the image features; applying combinatorial testing to ascertain a predetermined sequence of test cases, which each include a subcombination of the image features and/or value indications included in the list; generating at least one image file using a text-into-image generation algorithm, the file including a synthetic image assigned to the predetermined image category and has the image feature and the value indication; classifying the generated, synthetic image by means of the classification algorithm into at least one of the plurality of image categories; and ascertaining the misclassification value by comparing the image category classified by the classification algorithm with the predetermined image category.

### FIELD

The present invention relates to a computer-implemented method and to a system for ascertaining at least one systematic error during the classification of images into at least one image category by a classification algorithm.

### BACKGROUND INFORMATION

Certain image classification systems are described in the related art and relate to the task of extracting information from an image in order to make it possible to assign the image to a specific image category and/or image class on the basis of this information. The resulting cluster from such an image classification can be used to create, for example, thematic categories.

The classification of image data can in principle be carried out by a human analyst but is increasingly automated and carried out by machine learning approaches and/or artificial intelligence methods. In the conventional methods for classification of image data, misclassifications repeatedly occur in that images that are actually to be assigned to a specific category are assigned to a different category by the classification algorithm, due to image-specific and/or environment-specific and/or process-specific conditions.

One reason for such a misclassification is often systematic errors of an underlying classification algorithm. Systematic errors usually relate to a specific subgroup of images in which a trained classification algorithm has a high probability of a misclassification (“error”), wherein all images in the subgroup have certain properties in common. A human analyst would be able to assign this subgroup to the correct category without any problem, since a human analyst has sufficient domain knowledge or background knowledge and a large amount of experience. The subgroup of images classified incorrectly by the classification algorithm thus appears systematically coherent to a human observer, but is systematically classified incorrectly by a machine learning algorithm.

The presence of systematic errors is problematic for the use of classification algorithms in safety-critical fields. It is thus necessary to apply methods for checking the corresponding classification algorithm to systematic errors of this kind, in particular in these safety-relevant fields.

Several methods are described in the related art for recognizing systematic errors of a classification algorithm. For example, one of these methods has the name DOMINO and fits an error-aware mixture model of a classification algorithm into the latent space. A different method, on the other hand, embeds a linear support vector machine (SVM) classification algorithm into the latent space in order to differentiate image data from a class into correctly and incorrectly classified.

In the first case, clusters having a high error rate represent systematic errors, whereas in the second case, a vector points orthogonally to an SVM hyperplane in a direction of a systematic error. The identified, systematic errors can be interpreted by generating a label that is embedded in the vicinity of the cluster center or points in the SVM direction.

However, the conventional methods require the presence of a marked or labeled image data set (so-called hold-out sets), which was not used during training of the classification algorithm. In addition, the methods require separate multimodal embedding, which allows images and texts to be embedded in a common latent, i.e., not directly visible and/or detectable, space. There is therefore still potential for improvement.

### SUMMARY

An object of the present invention includes providing a computer-implemented method and/or a system for ascertaining at least one systematic error during the classification of images into at least one image category by a classification algorithm, which method at least partially overcomes the disadvantages of the related art and in particular functions without the provision of labeled image data that have not been used previously.

The object may be achieved by a computer-implemented method for ascertaining at least one systematic error during the classification of images into at least one image category by a classification algorithm have certain features of the present invention. The object may also be achieved by a system for ascertaining at least one systematic error during the classification of images into at least one image category by a classification algorithm have certain features of the present invention.

### SUMMARY

According to a first aspect of the present invention, a computer-implemented method is provided for ascertaining at least one systematic error during the classification of images into at least one image category by a classification algorithm. According to an example embodiment of the present invention, the method comprises at least the steps described below: providing at least one input text file, which comprises at least one keyword by means of which the input text file is assigned to a predetermined image category of a plurality of image categories, wherein the input text file comprises indications relating to at least one image feature for the predetermined image category and at least one value indication for the at least one image feature; providing a list of image features and respective value indications for each of the image features; applying combinatorial testing to ascertain a predetermined sequence and/or selection of test cases, which each comprise a subcombination and/or subgroup of combinations of the image features and/or value indications included in the list; generating at least one image file by means of a text-into-image generation algorithm, which image file comprises a synthetic image that is assigned to the predetermined image category, in particular with the subcombination of image features and/or with the subcombination of value indications according to one of the test cases; classifying the generated, synthetic image by means of the classification algorithm into at least one of the plurality of image categories; and ascertaining the at least one systematic error by comparing the image category classified by the classification algorithm with the predetermined image category.

According to a second aspect of the present invention, a system is provided for ascertaining at least one systematic error during the classification of images into at least one image category by a classification algorithm. According to an example embodiment of the present invention, the system comprises a providing device that is designed to provide at least one input text file, which comprises at least one keyword by means of which the input text file is assigned to a predetermined image category of a plurality of image categories, wherein the input text file comprises indications relating to at least one image feature for the predetermined image category and at least one value indication for the at least one image feature. The providing device is further designed to provide a list of image features and respective value indications for each of the image features. The system comprises an evaluating and computing device that is configured to apply combinatorial testing to ascertain a predetermined sequence of test cases, which each comprise a subcombination of the image features and/or value indications included in the list; to execute a text-into-image generation algorithm to generate at least one image file that comprises a synthetic image assigned to the predetermined image category according to one of the test cases and/or according to a feature combination and/or value indication combination included and/or specified in a particular test case; to execute a classification algorithm to classify the generated, synthetic image into at least one of the plurality of image categories; and to ascertain the at least one systematic error by comparing the image category classified by the classification algorithm with the predetermined image category.

The method and/or system according to example embodiments of the present invention is preferably designed to ascertain, on the basis of the generated, synthetic image data, at least one systematic error that occur(s) during the classification of the synthetic image data. According to the present invention, it is thus no longer necessary to provide labeled image data that have not yet been used for a classification in order to obtain information about a susceptibility to errors of a specific classification into a specific image category. Rather, in order to find such a systematic error, the image data are automatically generated by the text-into-image generation algorithm and already by generation are assigned to a specific image category due to the keyword indication. However, this assignment is not yet known to the classification algorithm before the actual classification of such a synthetically generated image, and therefore such a synthetically generated image can be used (without labeling by an expert) for ascertaining the misclassification value.

By applying combinatorial testing according to the present invention, it is also possible to ascertain multiple independent systematic errors without having to separately investigate every statistically possible feature combination and/or value indication combination. Such a complete statistical investigation of all possibilities would be very time-consuming and computationally intensive, in particular in the case of an input text file with many different indications relating to image features and/or with many different value indications for each of the image features. As the number of image features and/or value indications increases, the total number of possible combinations increases exponentially, which results in an exponentially increasing computing power.

In contrast, combinatorial testing forms an approximation to a complete combinatorial explosion of the image features and/or value indications. Depending on the selection of a cardinality n_{C} to be selected by preference in combinatorial testing, preferably only a subset of combinations of possible image features and/or value indications is selected in the form of the sequence of test cases, wherein for each of the test cases, i.e., for each combination of image features and/or value indications selected by combinatorial testing, preferably an image file is generated. Combinatorial testing preferably outputs the sequence of test cases, wherein each feature combination is inserted into the input text file, and therefore the feature indications specified therein are processed when the image data are generated.

It is self-evident that the at least one image file may also be a video file. The statements made in this application apply accordingly to video files to be generated. A text-in-video generation algorithm is then preferably used here.

Main advantages of the present invention include that it is not based on a metaheuristic that easily remains in a local optimum. In contrast, the method according to the present invention uses combinatorial tests that allow a uniform coverage of the operative design space (i.e., the combinatorial selection from the list of image features and associated value indications) and remain comprehensible, in particular for large operative design spaces (i.e., with a large number of image features and/or value indications).

Combinatorial testing preferably belongs to the class of so-called black-box testing methods, because it preferably does not derive the test cases from knowledge of the inner workings of the method, component or system. Rather, the approach consists in deriving test cases by systematically forming different input combinations.

The method and/or system according to the present invention can be used, for example, in the technical context of generic facial recognition and/or in the technical context of vehicle assistance systems and/or in the technical context of autonomous driving and/or in the technical context of computer vision and/or in the technical context of the quality monitoring of manufacturing components during automatic optical inspection and/or in the technical context of other technical fields in which image data are evaluated and/or categorized and/or classified, in order in this way to recognize misclassifications and to avoid or at least reduce misclassifications, preferably for future classifications, by correspondingly adapting the classification algorithm. Particularly preferably, the present invention can be used in the analysis of data that are obtained by at least one (image) sensor. According to an example embodiment of the present invention, the at least one sensor can, for example, ascertain measured values of an environment in the form of sensor signals. Such sensor signals can be present, for example, as digital images and/or videos. The sensor can be, for example, a camera and/or a lidar sensor and/or an ultrasonic sensor. The present invention can thus be used, for example, for image and/or video and/or audio analysis downstream of the detection, and there to classify the captured image data in order to recognize a misclassification rate and thus to be able to minimize same. The present invention can in particular be used to classify the sensor data and/or to recognize the presence of objects in the sensor data and/or to perform semantic segmentation of the sensor data, e.g., in relation to traffic signs, road surfaces, pedestrians and/or vehicles. According to the present invention, anomalies in the form of at least one systematic error of the technical system can be ascertained during the classification of the sensor data.

Such misclassifications in the classification of images can in principle occur in any classification of images by a classification algorithm for any image category. For example, such misclassifications can occur in the classification of faces into predetermined categories, such as age, sex, origin, skin color, etc. For example, such misclassifications can occur in the classification of images of a traffic situation if, for example, a vehicle included in the image is to be assigned to a specific vehicle category. For example, such misclassifications can occur in the classification of images of manufacturing components during automated quality control and/or manufacturing monitoring. The misclassification can be caused by the classification algorithm, for example, incorrectly interpreting peripheral image information present in addition to the object to be classified and/or incorrectly assessing background information and/or incorrectly assessing image properties and/or object properties of the object and/or object detail to be classified. The incorrect assessment can be caused, for example, by incorrect detection and/or assessment of geometric and/or optical properties of the object to be classified and/or the other image information.

The present invention thus aims to identify an in particular systematic error in the classification of images without the need for a marked or labeled holdout data set. According to the present invention, a text-into-image generation algorithm is used for this purpose, which can be implemented, for example, by the open-source algorithm “Stable Diffusion” (huggingface.co/CompVis/stable-diffusion). Such a text-into-image generation algorithm preferably maps text requests and/or text specifications, for example represented by the at least one keyword, onto a set of images, so that the images generated in this way preferably each reproduce something that corresponds to a meaning of the at least one keyword or the text request or by means of which the latter is described. For example, for a specific class c E C of an output space of the classification algorithm, an image that is included in this class C can be generated by a text request or the input text file, such as “an image of c with [ . . . ]”. Here, the class C preferably corresponds to the class with the systematic error that is to be identified by the classification algorithm during classification. In such a text request, text components that differ from the at least one keyword and do not relate to the class C can also be included. These text components are preferably included as peripheral image information by the text-into-image generation algorithm during the generation of images. According to the present invention such a text request or the input text file particularly preferably comprises, in addition to the image category, further indications relating to at least one image feature for the predetermined image category and at least one value indication for the at least one image feature, which are directly taken into account during the generation of the images and are preferably converted into graphical contents of the mapping space. Thus, by selecting the input text file, images of class C can be generated that preferably look realistic but occur in variable and/or non-typical contexts and/or poses and/or perspectives and/or other conditions. This is preferably determined according to the selection of the indications relating to at least one image feature and/or according to the value indication.

If the images synthetically generated in this way are then at least mostly classified incorrectly by the classification algorithm, i.e., c≠c, the systematic error and/or an indication of a misclassification can be ascertained. The generated images form candidates or an image request or image prompt of the misclassification, from which the at least one systematic error of the classification algorithm can preferably be derived. According to an example embodiment of the present invention, it is provided to preferably generate a plurality of different image data which, in particular, reproduce the sequence of test cases from the combinatorial tests, i.e., were generated according to the image features and/or value indications included therein.

The main disadvantage of the conventional methods for ascertaining a misclassification value is that they require the availability of a labeled holdout set for identifying systematic errors. Since systematic errors are also more likely to occur in unusual/rare data, their identification requires a holdout data set that contains such cases, which can be considered unrealistic. In contrast, the method according to the present invention works with synthetically generated image data that do not require manual marking or labeling. Furthermore, the synthesizing can be made dependent on a text prompt or an input text file. In this way, rare and/or unrealistic and/or statistically improbable image situations and/or mapping situations can also be synthesized by a correspondingly adapted text prompt. According to an example embodiment of the present invention, the method also at least partially automates the prompt engineering effort by using combinatorial tests in conjunction with the input text file template into which the respective image features and associated value indications are inserted for each test case to generate the image file. The method according to the present invention thus only requires access to a text-into-image generation algorithm, whereas previous work in the related art required access to a multimodal text-image embedding and a large labeled bridging set.

Within the meaning of the present disclosure, the term “plurality” is to be understood as multiple image categories. In other words, the wording “a plurality of image categories” is to be understood as meaning at least two image categories.

In a preferred example embodiment of the present invention, multiple input text files are provided, which each comprise the keyword assigned to the predetermined image category and in which the relevant indication relating to the at least one image feature and/or the relevant at least one value indication for the relevant image feature is/are varied according to the sequence of test cases ascertained by the combinatorial testing. An image file is preferably generated in each case for each of the multiple input text files, which image file comprises a synthetic image that is assigned to the predetermined image category and has the relevant at least one image feature and the relevant at least one value indication. Preferably, each of the generated, synthetic images is classified by the classification algorithm into at least one of the plurality of image categories. The at least one systematic error is preferably ascertained for each of the classified images. As a result, multiple images with different or mutually varied image features and/or with different or mutually varied value indications can be generated, so that these images are available to the classification algorithm for classification. The classification algorithm preferably classifies each of the generated images. If at least some of the images are classified incorrectly, commonalities of image features and/or value indications of these incorrectly classified images can be ascertained, for example. In this way, multiple systematic errors can preferably also be ascertained in parallel.

In a preferred embodiment of the present invention, the at least one systematic error for the relevant input text file and/or for the image file generated therefrom is stored. For this purpose, the system can comprise, for example, a storage device that is designed at least for temporary data storage. It can be a volatile and/or a non-volatile storage medium.

In a preferred example embodiment of the present invention, ascertaining the at least one systematic error comprises ascertaining a relevant misclassification value and preferably comparing the misclassification value ascertained in each case with a predetermined error limit value. In the case of the system, for example, the evaluating and computing device can be configured to ascertain the relevant misclassification value and preferably compare it with the predetermined error limit value. Alternatively, it is possible for the system to comprise a further ascertaining device for this purpose. By ascertaining the misclassification value, it can preferably be found out which weighting(s) for the occurrence of a systematic error a relevant image feature and/or a relevant value indication(s) comprises.

In a preferred embodiment of the present invention, if the ascertained misclassification value is equal to or exceeds the predetermined error limit value, the ascertained systematic error is added to a list of systematic errors. The system can, for example, comprise a generating device, which is designed to generate such a list of systematic errors. The generating device can be implemented by the evaluating and computing device or can be provided as a separate unit.

In a preferred embodiment of the present invention, the misclassification value is ascertained for each of the classified image files by comparing the image category classified by the classification algorithm with the predetermined image category. The evaluating and computing device can be configured to ascertain the misclassification value for each of the classified images by comparing the image category classified by the classification algorithm with the predetermined image category. For this purpose, the system can also comprise an independent device and/or unit.

The method according to an example embodiment of the present invention can also be described as follows. First, the in particular pretrained classification algorithm f is preferably provided, the in particular pretrained text-into-image generation algorithm G is provided, and the at least one input text file or request template T is provided, which comprises, in addition to the at least one keyword relating to the category or class c, preferably at least one indication relating to an image feature A₁, . . . , Aⱼ and at least one value indication aⱼ₁, . . . , a_{jMj} for the relevant image feature. Furthermore, the list of image features A₁, . . . , Aₖⱼ and the respective value indications aⱼ₁, . . . aⱼₘⱼ is provided. Particularly preferably, an indication of a cardinality n_{C} and/or an indication of a predetermined error limit value k is specified. Particularly preferably, combinatorial testing G is then carried out on the basis of the attributes Aᵢ, the attribute values aᵢⱼ and the cardinality n_{C}. Furthermore, an (initially empty) list of systematic errors: E={ } is preferably created. If a new test case g∈G is then generated and/or created in the combinatorial test suite (i.e., by the combinatorial testing), and thus exists, the at least one input text file T is particularly preferably instantiated according to the test case g. Thus, the text request t=T(g) is obtained. Particularly preferably, R samples are taken from the text-image model x₁, . . . x_{R}˜G(t(g)). Particularly preferably, a misclassification value and/or a misclassification rate f is ascertained for the samples, where

$$f = 1 / R {\sum }_{i = 1}^{R} {1}_{f ( x i ) \neq c i} .$$

Particularly preferably, g is added to the list E as an ascertained systematic error if f≥κ. According to the present invention, the output is preferably a list of systematic errors E.

In a preferred embodiment of the present invention, the classification algorithm and/or the text-into-image generation algorithm comprise(s) in each case machine learning algorithms that are preferably pretrained. Generally, the classification algorithm and/or the text-into-image generation algorithm can comprise a machine learning algorithm or an analytically operating algorithm or a mixing algorithm. The classification algorithm and/or the text-into-image generation algorithm can preferably be pretrained by incorporating domain knowledge and/or expert knowledge and/or labeled training data.

In a preferred embodiment of the present invention, the machine learning algorithm comprises a polynomial regression method and/or a method of regression by means of an in particular multi-layered neural network. Other machine learning approaches are also possible in principle. For example, the machine learning algorithm can be designed at least partially as a neural network and/or as a monitored learning algorithm and/or as a partially monitored learning algorithm and/or as an unmonitored learning algorithm and/or as a reinforcement learning algorithm. Hybrid algorithms, which link multiple machine learning approaches to one another, can also be used.

The present invention further relates to a computer program having program code in order to carry out at least parts of the method according to the present invention according to any embodiment when the computer program is executed on a computer.

The present invention further relates to a computer-readable data carrier having program code of a computer program in order to carry out at least parts of the method according to the present invention according to any embodiment when the computer program is executed on a computer.

The described embodiments and developments of the present invention can be combined with one another as desired.

Further possible embodiments of the present invention, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate example embodiments and, in connection with the description, serve to explain principles and concepts of the present invention. Other embodiments and many of the mentioned advantages are apparent from the figures and the disclosure herein. The illustrated elements of the figures are not necessarily shown to scale relative to one another.

FIG. 1 is a schematic flowchart of the method according to an example embodiment of the present invention.

FIG. 2 is a schematic diagram of generically generated images of a specific class c that are to be classified.

FIG. 3 is a schematic flowchart of a classification method, according to an example embodiment of the present invention.

### DETAILED DESCRIPTION OF EXAMPLE EMBODIMENTS

In the figures, identical reference signs denote identical or functionally identical elements, parts or components, unless stated otherwise.

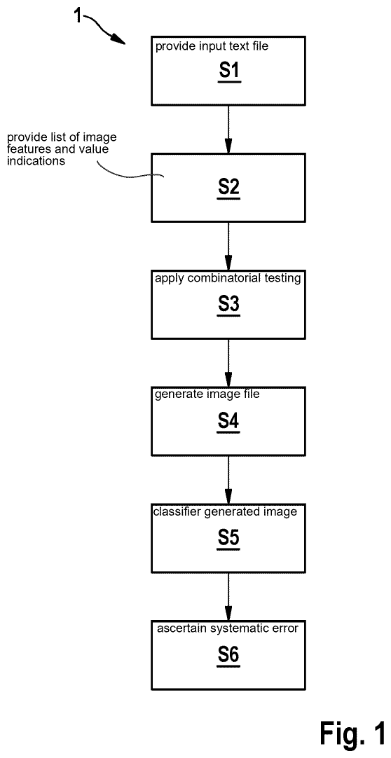

FIG. 1 shows a schematic flowchart of a computer-implemented method for ascertaining at least one systematic error during the classification of images into at least one image category by a classification algorithm. In any embodiment, the method can be carried out at least partially by a system 1 that can comprise, for this purpose, multiple components (not shown in detail), for example one or more providing devices and/or at least one evaluating and computing device. It is self-evident that the providing device can be designed together with the evaluating and computing device or can be different therefrom. Furthermore, the system can comprise a storage device and/or an output device and/or a display device and/or an input device.

According to the present invention, the computer-implemented method comprises at least the following steps:

In a step S1, providing at least one input text file, which comprises at least one keyword, optionally also multiple, in particular appropriately mutually complementary keywords, by means of which the input text file is assigned to a predetermined image category of a plurality of image categories. The input text file comprises indications relating to at least one image feature, preferably indications relating to multiple image features, for the predetermined image category and at least one value indication for the at least one image feature. In this case, an example of the input text file may be “An orange minivan in front of snow-covered trees,” wherein “minivan” is the keyword assigning the image category, wherein “color” is a first exemplary image feature, wherein “orange” is the value indication for this image feature, wherein “background” is a second exemplary image feature, and wherein “snow-covered trees” is preferably a value indication for this image feature, in particular understood in the context. Of course, the aforementioned input text file is only exemplary in nature. In the present example, the predetermined image category is “minivan.”

In a step S2, a list of image features and respective value indications for each of the image features is provided.

In a step S3, combinatorial testing is applied to ascertain a predetermined sequence of test cases, which each comprise a subcombination of the image features and/or value indications included in the list.

In a step S4, at least one image file is generated by means of a text-into-image generation algorithm, which image file comprises a synthetic image that is assigned to the predetermined image category with according to one of the test cases. Based on the aforementioned example of an input text file, an image comprising a minivan is thus generated.

In a step S5, the generated, synthetic image is classified by means of the classification algorithm into at least one of the plurality of image categories. Based on the aforementioned example, the generated image comprising the orange minivan is classified into an image category or assigned to such an image category. If the classification algorithm is working correctly, the generated image should actually be classified into the “minivan” category.

In a step S6, the at least one systematic error is ascertained by comparing the image category classified by the classification algorithm with the predetermined image category. For example, it is possible for the classification algorithm to incorrectly assign the generated image with the orange minivan to another category, since, for example, it incorrectly fails to identify a minivan due to the snow-covered background and/or the “orange” coloring, for example if the classification algorithm has not correctly learned this during training, since the training data provided did not include such an image of a minivan with a corresponding label. For such an incorrect classification, a misclassification value is then preferably ascertained, which for example in the simplest case indicates whether the image was classified correctly (numerically “1”) or incorrectly (numerically “0”). This fed-back check is preferably possible because the synthetically generated images comprise a unique indication for the predetermined image category corresponding to the keyword, before the image is generated and classified by the classification algorithm.

In mathematical terms, according to the present invention, a pretrained (image) classification algorithm f: X→C is assumed, which assigns an image x∈X to a class c∈C. Furthermore, images are preferably provided that originate from a distribution x˜D and for which C is a basic truth value, i.e., in other words, each of the provided images is unambiguously assigned to category c.

Of interest according to the present invention is a systematic error of f, i.e., for subsets i=1 . . . . K of data X⁽ⁱ⁾⊂X which preferably satisfy at least one of the following conditions:
(i) a sufficient probability of occurrence of the systematic error under [symbol] :[∫_{xEX(i)}p_{D} (x)]>ε; and/or
(ii) the same basic truth class c for X⁽ⁱ⁾:∃c:C(x)=c∀x∈X⁽ⁱ⁾;
(iii) a high probability of error of f to X⁽ⁱ⁾: P[f(x)X⁽ⁱ⁾:

$$ℙ [ f ( x ) \neq C ( x ) ] \geq κ ;$$

(iv) all data of X⁽ⁱ⁾ have certain properties.

The last condition (vi) can be realized, for example, by a corresponding feature classification Aⱼ, which assigns attributes a=Aⱼ (x) to the data x. In this case, the condition (iv) can preferably be interpreted as ∃j, a: Aⱼ(x)=a ∀x∈X⁽ⁱ⁾.

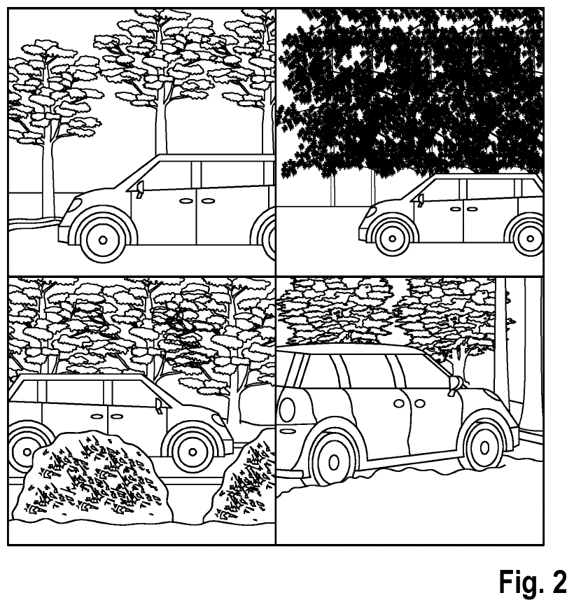

Furthermore, according to the present invention, a provided text-into-image generation algorithm g:T×N→X is assumed, for example the convention text-into-image generation algorithm “Stable Diffusion” (huggingface.co/CompVis/stable-diffusion). Here, t∈T is preferably an input text file or text prompt, and n∈N is preferably at least one randomly selected disturbance variable. Alternatively, this can be considered as a distribution X≠G (t), wherein the at least one disturbance variable is preferably part of the distribution, and the distribution preferably depends on the input text file or the text request t associated therewith. If g was trained such that it generates data from D (or a similar distribution), x˜G (t) is preferably generated such that the above condition (i) for data from G (t) is met. If the text request is designed accordingly, x≠G (t) preferably belongs to a target class c, i.e., C (x)=c with at least one feature a=Aⱼ (x). This preferably meets the conditions (ii) and (iv). For example, for an input text file or input request such as “An image of an orange minivan with a background of snowy trees,” images of the class “minivan” are generated, in which the attribute A_{color} has the value “orange,” and the attribute A_{background} has the value “snowy trees” (see FIG. 2).

The specific design of input text files or input text requests (also called prompts), for example a template T that allows the encoding of different combinations of class C (x)=c and attribute values aⱼ₁=Aⱼ₁ (x), . . . , aⱼₖ=Aⱼₖ (x) is preferably flexible, but preferably benefits from a certain amount of experience or prior knowledge in designing prompts for model g. An option for such an input text file can be “An image of class c with Aⱼ₁ and Aⱼ₂.” In this way, the above input text request “A picture of an orange minivan with a background of snowy trees” can be instantiated for c=“a minivan” and Aⱼ₁=“color” and aⱼ₁=“orange” and Aⱼ₂=“background” and aⱼ₂=“snowy trees.”

In a preferred template instantiation of such an input text file or input text request, the space for structuring such an input text file increases combinatorially with the number of possible attributes Aⱼ, j=1 . . . Kⱼ. As the number of features increases, it becomes difficult to obtain a combination of features that has a high misclassification rate and thus leads to a systematic error within the meaning of condition (iii). To solve this problem, the present invention proposes the use of a combinatorial test. Preferably, not all possible attribute combinations are tested, but only a preferred subset of test cases is generated. For a cardinality n_{C} selected by the user, combinatorial tests preferably ensure that, for any combination of values of any n_{C} attributes, at least one test case exists that has these attributes.

Explained with an example, this means: Assume there are three different image features or image attributes A with the value indications a₁, a₂, a₃, B with the value indications b₁, b₂, b₃/and C with the value indications c₁, c₂, c₃. Furthermore, the cardinality n_{C}=2 is set for combinatorial testing. For n_{C}=2 there is now for each (aᵢ,bⱼ) a test case with these value indications, for each (aᵢ,cⱼ) a test case with these value indications and for each (bᵢ,cⱼ) a test case with these value indications (for any i, j). However, combinatorial testing preferably does not output a test case for the combination (aᵢ,bⱼ,cⱼ), because n_{C}=2 was set, and thus only a subcombination of possible combinations was generated. Instead of identifying only a single systematic error, combinatorial testing also allows the detection of a large subset of systematic errors, preferably when they are above a certain error threshold.

FIG. 2 shows by way of example four synthetically generated images, which all show the image category “minivan,” wherein at least one image feature and/or a value indication for a corresponding image feature was varied between the images. For example, the image shown top left shows an orange minivan against a background of white, snowy deciduous trees, with the background appearing almost entirely white on white. For example, the top right image shows an orange minivan against a background of snowy conifers, with the background appearing significantly darker relative to the top left image. For example, the bottom left image shows an orange minivan against a background of snowy deciduous trees, with hedges visible in an image plane in front of the minivan. For example, the bottom right image shows an orange minivan against a background of snowy trees, which also differs from the other backgrounds. The arrangement of the minivan also differs in each picture.

It is then possible, for example, for the classification algorithm to incorrectly classify the top left image due to the background, which appears white on white in comparison with the other image backgrounds, and thus assign it to an incorrect image category “snowplow” instead of to the image category “minivan,” for example. According to the present invention, this systematic classification error can be detected.

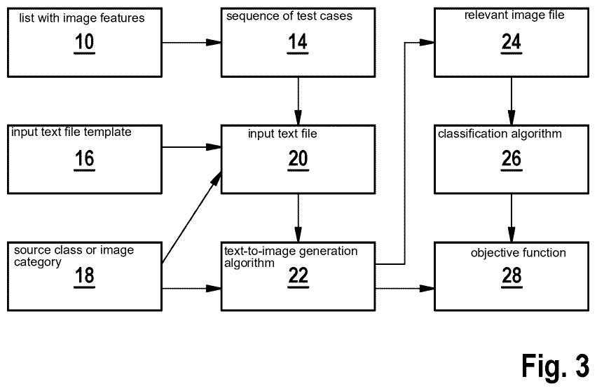

FIG. 3 describes a schematic block diagram. A domain expert and/or a user and/or a subject matter expert defines a list 10 with image features, in particular in the form of semantic dimensions and possible value indications for these dimensions. Using the minivan as an example, image features can include, for example, a viewing direction with exemplary value indications “frontal, rear, side, etc.,” a color with exemplary value indications “red, green, blue, orange, etc.,” a weather in the background with the value indications “sunny, rainy, snowy, etc.,” and a background with the value indications “lake, house, trees, etc.” From this list 10, a sequence of test cases 14 is generated by means of combinatorial testing 12, which test cases comprise a combination selection from the list, for example a test case with the viewing direction “rear,” the color “orange,” the weather “snowy,” and the background “trees.”

Furthermore, an input text file template 16 is provided, which comprises, for example, a variable format “{viewing direction} of a {color} {class C} in front of a {weather} {background}.” This input text file template 16 is of course to be understood purely by way of example.

Furthermore, a source class C or an image category 18, for example {Class C}=“minivan,” is provided as input variable.

Based on the relevant test case 14, the input text file template 16, and the source class 18, an input text file 20 is generated, by way of example in the form of “rear view of an orange minivan in front of snowy trees.”

By querying a text-into-image generation algorithm 22, such as Stable Diffusion, a relevant image file 24 is generated on the basis of this input text file 20.

The relevant image file 24 is provided as input for a classification algorithm 26.

The predictions of the classification algorithm 26 are preferably compared with the source class C or 22 using an objective function 28, in particular using robust statistics. A large deviation between the output class and the predictions preferably indicates a possible systematic error.

1-10. (canceled)

11. A computer-implemented method for ascertaining at least one systematic error in a classification of images into at least one image category by a classification algorithm, the method comprising the following steps:
providing at least one input text file template, which includes at least one keyword using which the input text file template is assigned to a predetermined image category of a plurality of image categories, wherein the input text file template includes indications relating to at least one image feature for the predetermined image category and at least one value indication for the at least one image feature;
providing a list of image features and respective value indications for each of the image features;
applying combinatorial testing to ascertain a predetermined sequence of test cases, which each include a subcombination of the image features and/or value indications included in the list;
generating, by inserting the subcombination of the image features and/or value indications included in the list into an input text file, at least one image file using a text-into-image generation algorithm, the image file including a synthetic image that is assigned to the predetermined image category according to one of the test cases;
classifying the generated, synthetic image using the classification algorithm into at least one of the plurality of image categories; and
ascertaining the at least one systematic error by comparing the image category classified by the classification algorithm with the predetermined image category;
wherein the combinatorial testing for a cardinality selected by a user of the sequence of test cases is generated in such a way that for any combination of cardinality value indications of any image attributes, at least one test case exists that has the value indication, and that no test case is generated for a combination of value indications in which a number of value indications is unequal to the cardinality.

12. The computer-implemented method according to claim 11, wherein multiple input text files are provided, each of the multiple input text files including a respective keyword assigned to a respective predetermined image category, and wherein a respective relevant indication relating to at least one respective image feature and/or a relevant at least one value indication for the respective relevant image feature is varied according to the sequence of test cases ascertained by the combinatorial testing; wherein a respective image file is generated in each case for each of the multiple input text files, which respective image file includes a respective synthetic image that is assigned to the respective predetermined image category and has the at least one respective image feature and the respective relevant at least one value indication; wherein each of the respective generated, synthetic images is classified by the classification algorithm into at least one of the plurality of image categories, and wherein the at least one systematic error is ascertained for each of the respective classified images.

13. The computer-implemented method according to claim 12, wherein the method further comprises the following steps:
storing the at least one systematic error for each of the input text files.

14. The computer-implemented method according to claim 12, wherein ascertaining the at least one systematic error includes ascertaining a relevant misclassification value and comparing the relevant misclassification value ascertained in each case with a predetermined error limit value.

15. The computer-implemented method according to claim 14, wherein, when the ascertained misclassification value is equal to or exceeds the predetermined error limit value, the ascertained systematic error is added to a list of systematic errors.

16. (canceled)

17. The computer-implemented method according to claim 11, wherein the classification algorithm and/or the text-into-image generation algorithm each include machine learning algorithms that are pretrained.

18. A system for ascertaining at least one systematic error during classification of images into at least one image category by a classification algorithm, the system comprising:
a providing device configured to provide at least one input text file template, which includes at least one keyword by means of which the input text file template is assigned to a predetermined image category of a plurality of image categories, wherein the input text file template includes indications relating to at least one image feature for the predetermined image category and at least one value indication for the at least one image feature, and the providing device is further configured to provide a list of image features and respective value indications for each of the image features; and
an evaluating and computing device configured to:
apply combinatorial testing to ascertain a predetermined sequence of test cases, which each includes a subcombination of the image features and/or value indications included in the list;
execute a text-into-image generation algorithm to generate at least one image file that a synthetic image assigned to the predetermined image category according to one of the test cases, by inserting the subcombination of the image features and/or value indications included in the list into an input text file;
execute a classification algorithm to classify the generated, synthetic image into at least one of the plurality of image categories; and
ascertain the at least one systematic error by comparing the image category classified by the classification algorithm with the predetermined image category;
wherein the combinatorial testing for a cardinality selected by a user of the sequence of test cases is generated in such a way that for any combination of cardinality value indications of any image attributes, at least one test case exists that has the value indication, and that no test case is generated for a combination of value indications in which a number of value indications is unequal to the cardinality.

19. A non-transitory computer-readable data carrier on which are stored program code of a computer program for ascertaining at least one systematic error in a classification of images into at least one image category by a classification algorithm, the program code, when executed by a computer, causing the computer to perform the following steps:
providing at least one input text file template, which includes at least one keyword using which the input text file template is assigned to a predetermined image category of a plurality of image categories, wherein the input text file template includes indications relating to at least one image feature for the predetermined image category and at least one value indication for the at least one image feature;
providing a list of image features and respective value indications for each of the image features;
applying combinatorial testing to ascertain a predetermined sequence of test cases, which each include a subcombination of the image features and/or value indications included in the list;
generating, by inserting the subcombination of the image features and/or value indications included in the list into an input text file, at least one image file using a text-into-image generation algorithm, the image file including a synthetic image that is assigned to the predetermined image category according to one of the test cases;
classifying the generated, synthetic image using the classification algorithm into at least one of the plurality of image categories; and
ascertaining the at least one systematic error by comparing the image category classified by the classification algorithm with the predetermined image category;
wherein the combinatorial testing for a cardinality selected by a user of the sequence of test cases is generated in such a way that for any combination of cardinality value indications of any image attributes, at least one test case exists that has the value indication, and that no test case is generated for a combination of value indications in which a number of value indications is unequal to the cardinality.
